(19) United States
(12) Patent Application Publication
(10) Pub. No.: US 2022/0305372 A1
(43) Pub. Date: Sep. 29, 2022

(54) Puzzle Storage Apparatus

(71) Applicant: Carter Stephenson, Wales, WI (US)

(72) Inventor: Carter Stephenson, Wales, WI (US)

(21) Appl. No.: 17/404,192

(22) Filed: Aug. 17, 2021

Related U.S. Application Data
(60) Provisional application No. 63/164,792, filed on Mar. 23, 2021.

(51) Int. Cl. A63F 9/10; A47B 23/00; A47B 3/08; A47B 37/00; B62B 3/10; B62B 3/02; B62B 5/04

(52) U.S. Cl. CPC A63F 9/1044; A47B 23/001; A47B 3/08; A47B 37/00; B62B 3/10; B62B 3/02; B62B 5/04; A47B 2220/0077; B62B 2301/0467; A63F 2009/105

(57) ABSTRACT

A puzzle storage apparatus configured to retain a jigsaw puzzle in a partially complete or fully completed state. The puzzle storage apparatus is dimensioned to fit under furniture, such as a couch or bed, for easy out of sight puzzle storage and protection. The puzzle storage apparatus comprises a board tray and a rolling component. The board tray is designed to allow a user to construct a jigsaw puzzle on a top surface of the board tray. The rolling component allows the user to easily roll the board tray with the partially or fully completed jigsaw puzzle under the furniture when the user is not working on the puzzle.

### CROSS-REFERENCE TO RELATED APPLICATION

The present application claims priority to, and the benefit of, U.S. Provisional Application No. 63/164,792, which was filed on Mar. 23, 2021 and is incorporated herein by reference in its entirety.

### FIELD OF THE INVENTION

The present invention generally relates to a way to secure and store puzzles, and more specifically to a puzzle storage apparatus configured to keep jigsaw puzzles protected before and after they are completed. Accordingly, the present specification makes specific reference thereto. However, it is to be appreciated that aspects of the present invention are also equally amenable to other like applications, devices, and methods of manufacture.

### BACKGROUND

A jigsaw puzzle is a puzzle type game that requires the assembly of generally oddly shaped interlocking tile pieces. Typically, each individual puzzle piece has a portion of a picture that when assembled, creates a complete picture. Jigsaw puzzles are usually constructed using, cardboard stock, paperboard or a similar inexpensive material. An enlarged photograph, printed reproduction of a painting, or similar two-dimensional artwork is glued to or printed on the stock cardboard material. The cardboard stock is then fed into a press. The press cuts the desired pattern using a set of hardened steel blades. The puzzle cutting process is similar to creating shaped cookies with a cookie cutter.

Jigsaw puzzles come in a variety of different sizes. Puzzles can range from smaller 300-750 piece puzzles to larger several thousand piece puzzles. A typical layout for a thousand-piece puzzle is 38 pieces by 27 pieces, for an actual total of 1,026 pieces. A typical 500-piece puzzle is typically 27 pieces by 19 pieces. A fully interlocking puzzle is configured so that adjacent pieces are connected in such a way that if one is moved horizontally, the others stay attached to it. Most jigsaw puzzles are square, rectangular, or round in shape, with edge pieces having one straight or smoothly curved side, plus four corner pieces if the puzzle is square or rectangular. However, some puzzles have edge and corner pieces cut like the rest, with no straight sides, making it more challenging to identify them. Other puzzles utilize more complex edge pieces to form special shapes when assembled.

When working on a puzzle, a flat surface is required for assembly. Many puzzles are not completed in a single session and storing an unfinished puzzle to work on later can be complicated. Puzzle pieces often go missing if left sitting out on an open table. In addition, valuable space is consumed by an unfinished puzzle left out in the open. However, moving the puzzle from a working surface to a safe location can be difficult to do without the puzzle falling apart while it is moved for safe keeping.

Several options exist to overcome the storage problem. Construction trays are a basic jigsaw puzzle accessory. Unfortunately, a stand-alone construction tray cannot be packed away and stored with a part-assembled jigsaw. However, they can very easily be moved around from place to place in a home. A roll-up mat is another option for use in puzzle construction. Mats may have coarse texture to which cardboard jigsaw pieces adhere. The non-assembled pieces are also kept on the cloth. When the puzzle needs to be cleared away the entire cloth is rolled around a drum thus keeping both the assembled and non-assembled pieces trapped in position until the cloth is unrolled again. This is not the most effective way to store a partially completed puzzle as it can still break apart.

A portfolio case can be used where the puzzle is constructed on one side of the case and the unassembled pieces are kept either on the other side. A foam-backed lining on either side of the case exerts enough pressure to keep the jigsaw pieces in place when closed. While this is better at keeping pieces in place than a mat, it involves more assembly and is consequently more expensive. Puzzles can also be permanently glued directly onto a backing board. Once glued, the puzzle is placed into a frame in much the same way as a picture is fitted in a picture frame. However, gluing a jigsaw puzzle to a board renders it unusable in the future as a puzzle as it is a one-time option.

Accordingly, there is a great need for an apparatus configured to store incomplete jigsaw puzzles. There is also a need for a way for users to easily move a completed or incomplete jigsaw puzzle to a safe location that does not take up living space, such as under a couch or bed. Similarly, there is a need for an apparatus that prevents completed work on a puzzle from being disrupted or ruined by others. There is also a need for an option that allows puzzlers the ability to work on a jigsaw puzzle at their own pace and store it away until they are ready to work on it again. Further, there is a need for a flat surface ideal for jigsaw puzzle building that includes wheels so that the entire unit can be moved to a storage location when the user is not working on the jigsaw puzzle.

In this manner, the improved puzzle storage apparatus of the present invention accomplishes all of the forgoing objectives, thereby providing an easy solution for safely store an incomplete jigsaw puzzle away from children, pets, guests. A primary feature of the present invention is a rollable work surface that can retain the jigsaw puzzle yet facilitate access to an out of sight storage area such as under furniture. The present invention allows the user to work on a jigsaw puzzle at their own pace while preserving usable living space for other uses. Finally, the improved puzzle storage apparatus of the present invention is capable of easy retrieval of a jigsaw puzzle from a hard or inconvenient to access storage area, such as under a bed or couch.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a puzzle storage apparatus. The puzzle storage apparatus is configured to retain a jigsaw puzzle during puzzle assembly and store the incomplete or completed jigsaw puzzle when not in use. The puzzle storage apparatus comprises a board tray and a rolling component. The rolling component is attached to the board tray allowing the puzzle storage apparatus to roll under a couch or bed for safe storage.

The board tray comprises a top surface, a bottom surface, and a perimeter wall. The board tray is a thin flat workspace designed for building and retaining a jigsaw puzzle. The perimeter wall comprises a front wall, a back wall, and a pair of side walls. The front and back walls are connected by the pair of side walls at four corners so that the board tray is generally rectangular or square in shape. The distance between the front and back walls, or depth of the board tray is typically approximately twenty inches or less to fit under furniture, but it is contemplated that the depth may be greater if desired. The overall height of the puzzle storage apparatus is typically approximately two inches or less, but it is contemplated that the height may be taller if desired.

The top surface can be a non-slip surface for holding jigsaw puzzle pieces in place on the top surface. The board tray may further comprise a lip. The lip is molded into and extends generally upward out of the perimeter or is attached to the top surface adjacent to the perimeter. The board tray may further comprise at least one handle. The at least one handle may be molded into or attached to the board tray anywhere along the perimeter.

The board tray may further comprise a first panel and a second panel. The second panel is partially housed within the first panel and extends laterally outward to increase the width of the board tray between the pair of sides as needed. The puzzle storage apparatus may further comprise a surface protective element. The surface protective element is removably attachable to the board tray and may be positioned over the incomplete or completed puzzle resting on the top surface for further protection.

The rolling component is attachable to the bottom surface of the board tray. The rolling component is configured to allow the puzzle storage apparatus to move in any direction. The rolling component comprises a plurality of castors. The plurality of castors are attached to the bottom surface of the board tray, one at each of the four corners. Each castor comprises a mounting bracket retaining a wheel and may further comprise a brake for preventing movement. Alternatively, the rolling component comprises a dolly attachable to the bottom surface of the board tray. The dolly is detachable from the board tray. The dolly comprises a frame and a plurality of castors attached to the frame.

The puzzle storage apparatus may further comprise a plurality of legs. Each leg is foldably attached to the bottom surface of the board tray. Each leg folds downward to allow the puzzle storage apparatus to function as a table and retracts up against the bottom surface for storage. The puzzle storage apparatus may further comprise a lighting component attachable to the board tray for illuminating the top surface of the board tray. The puzzle storage apparatus may further comprise a drawer assembly. The drawer assembly is attachable to the bottom surface of the board tray and extends outward from the perimeter.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of a puzzle storage apparatus of the present invention for use in constructing and storing a puzzle under a piece of furniture in accordance with the disclosed architecture.

FIG. 2 illustrates an overhead perspective view of the puzzle storage apparatus of the present invention for use in constructing and storing a puzzle in accordance with the disclosed architecture.

FIG. 3 illustrates an overhead perspective view of the puzzle storage apparatus of the present invention for use in constructing and storing a puzzle in accordance with the disclosed architecture.

FIG. 4 illustrates an underneath perspective view of the puzzle storage apparatus of the present invention for use in constructing and storing a puzzle in accordance with the disclosed architecture.

FIG. 5 illustrates a close up perspective view of a rolling component of the puzzle storage apparatus of the present invention for use in constructing and storing a puzzle in accordance with the disclosed architecture.

FIG. 6 illustrates an underneath perspective view of the puzzle storage apparatus of the present invention for use in constructing and storing a puzzle in accordance with the disclosed architecture.

FIG. 7 illustrates an overhead perspective view of the puzzle storage apparatus of the present invention for use in constructing and storing a puzzle in accordance with the disclosed architecture.

FIG. 8 illustrates a side view of a protective element of the puzzle storage apparatus of the present invention for use in constructing and storing a puzzle in accordance with the disclosed architecture.

FIG. 9 illustrates a side view of a first and second panel of a board tray of the puzzle storage apparatus of the present invention for use in constructing and storing a puzzle in accordance with the disclosed architecture.

FIG. 10 illustrates a perspective view of a drawer assembly of the puzzle storage apparatus of the present invention for use in constructing and storing a puzzle in accordance with the disclosed architecture.

FIG. 11 illustrates a side view of a board tray and a dolly of the puzzle storage apparatus of the present invention is a detached configuration for use in constructing and storing a puzzle in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

The present invention, in one exemplary embodiment, offers an ideal apparatus to complete a puzzle that allows the user to roll the unit away to a safe location when not needed. The puzzle storage apparatus may be constructed as a plastic flat surface base that has attached casters or wheels. The casters or wheels can be glued, screwed, or riveted under the flat plastic surface in each corner. To fit under sofas, the depth of the flat plastic surface is typically approximately twenty inches or less, and approximately two inches or less in height. The user can puzzle build on the surface and then roll it away to a storage location.

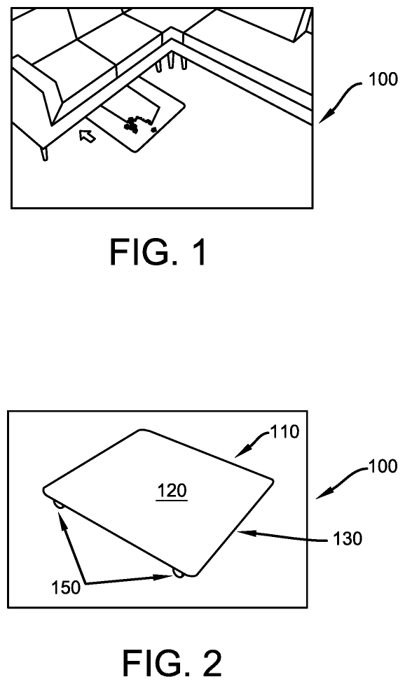

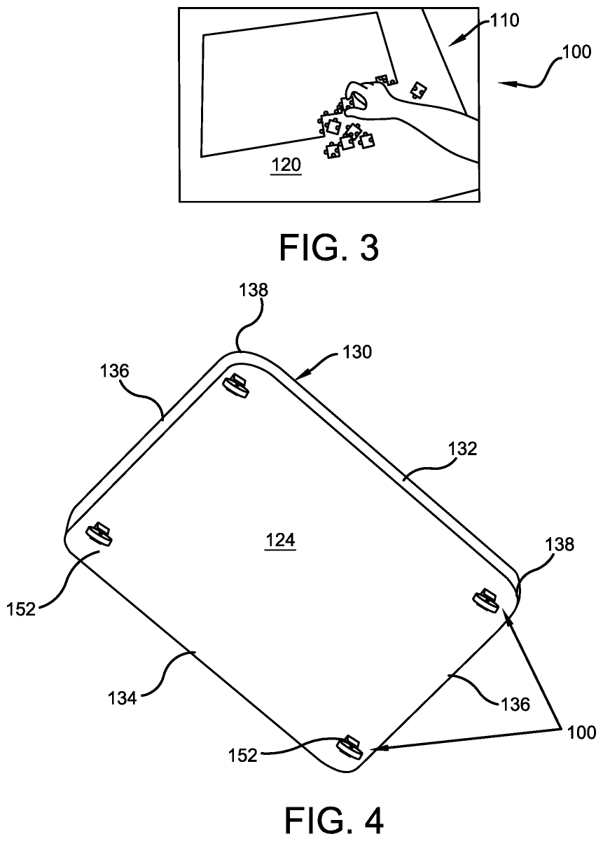

Referring initially to the drawings, FIGS. 1-11 illustrate a puzzle storage apparatus 100. As illustrated in FIGS. 1-3, the puzzle storage apparatus 100 is configured to retain a jigsaw or similar puzzle during puzzle assembly and store the incomplete or completed jigsaw puzzle safely and out of sight when not in use. The puzzle storage apparatus 100 comprises a board tray 110 and a rolling component 150. The rolling component 150 is attached to the board tray 110 allowing the puzzle storage apparatus 100 to roll under a couch or bed for safe storage as illustrated in FIG. 1. The rolling component 150 may be detachable or foldable.

As illustrated in FIGS. 2-4, the board tray 110 comprises a top surface 120, a bottom surface 124, and a perimeter wall 130. The board tray 110 is constructed as a thin flat workspace designed for building and retaining a jigsaw puzzle and its pieces. The board tray 110 is typically manufactured from a sturdy plastic material but may be wood or metal as desired. The perimeter wall 130 comprises a front wall 132, a back wall 134, and a pair of side walls 136. The front and back walls 132 and 134 are connected by the pair of side walls 136 at four corners 138 so that the board tray 110 is generally rectangular or square in shape. This is not meant as a limitation, as it is contemplated that board tray 110 may be any geometric shape to accommodate differently shaped puzzles as desired.

The distance between the front and back walls 132 and 134, or depth of the board tray 110 is typically approximately twenty inches or less to fit under furniture, but it is contemplated that the depth may be greater if desired. The height of the puzzle storage apparatus 100 is typically approximately two inches or less, but it is contemplated that the height may be taller if desired. This is advantageous as a couch, sofa, or chair typically has a low profile with limited depth leaving the space underneath as not usable for storage applications. Alternatively, a bed may have a higher profile that can accommodate a slightly taller or deeper puzzle storage apparatus 100.

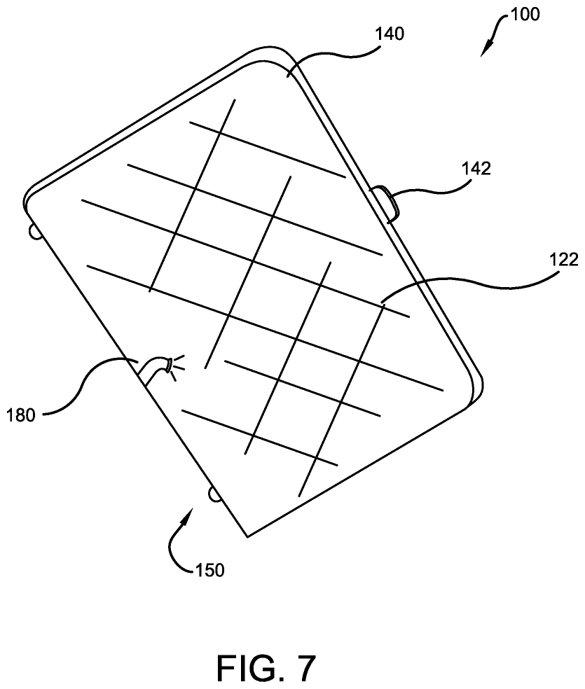

As illustrated in FIG. 7, the top surface 120 can be a non-slip surface 122 for helping to hold jigsaw puzzle pieces in place on the top surface 120. The board tray 110 may further comprise a lip 140. The lip 140 or rim may be molded into and extends generally upward out of the perimeter wall 130 or is attached to the top surface 120 adjacent to the perimeter wall 130. The lip 140 is low profile and just high enough to prevent puzzle pieces from sliding off of the top surface 120. The board tray 110 may further comprise at least one handle 142. The at least one handle 142 may be molded into or otherwise attached to the board tray 110 anywhere along the perimeter 130. The at least one handle 142 may also be a string or similar type of pull.

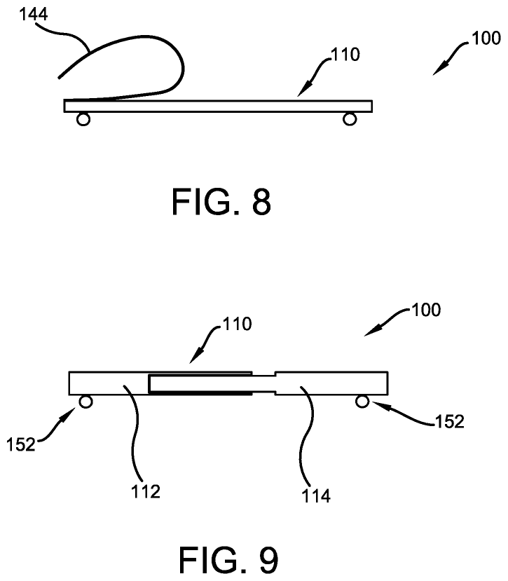

As illustrated in FIG. 9, the board tray 110 may further comprise a first panel 112 and a second panel 114. The second panel 114 may be partially housed within the first panel 112 and extends laterally or telescope outward to increase a width of the board tray 110 between the pair of side walls 136 as needed. This allows the puzzle storage apparatus 100 to accommodate larger sized puzzles. As illustrated in FIG. 8, the puzzle storage apparatus 100 may further comprise a surface protective element 144. The surface protective element 144 may be a rollable membrane or flexible sheet. The surface protective element 144 is removably attachable to a portion of the board tray 110 and may be positioned over the incomplete or completed puzzle resting on the top surface 120 for further protection during storage.

The rolling component 150 is attachable to the bottom surface 124 of the board tray 110. The rolling component 150 may be permanently attached or may be detachable. The rolling component 150 is configured to allow the puzzle storage apparatus 100 to move in any direction. The rolling component 150 comprises a plurality of castors 152. The plurality of castors 152 are attached to the bottom surface 124 of the board tray 110, one castor 152 typically at each of the four corners 138. Alternatively, the rolling component 150 may comprise bearing wheels, or other similar swivel-type wheels.

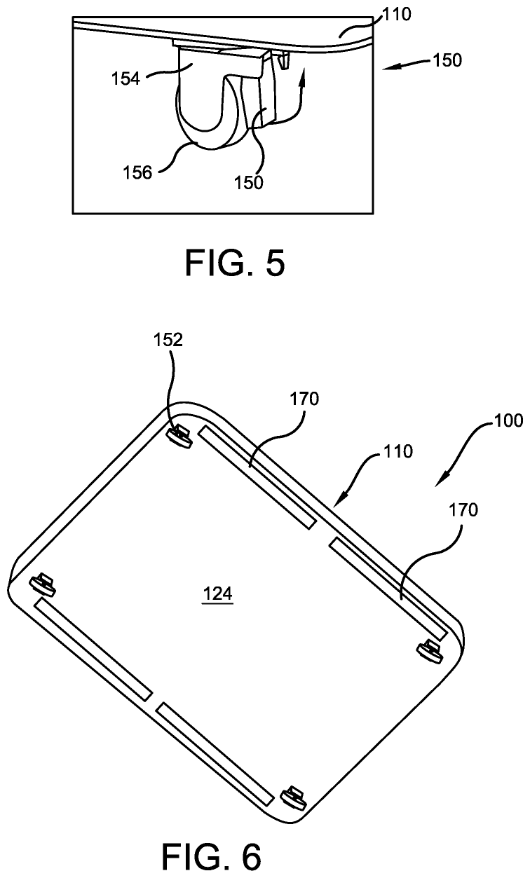

Each castor 152 may comprise a mounting bracket 154 and a wheel 156. Each mounting bracket 154 is rotatably attached to the board tray 110 so that each castor 152 may swivel. Each mounting bracket 154 retains the associated wheel 156. Each castor 152 may further comprise a brake 158 for stopping movement. Each castor 152 may be mechanically or adhesively attached to the bottom surface 124 via mechanical fasteners, screws, rivets, glue, or a combination thereof. Each castor 152 may also be configured to fold inward up against the bottom surface 124 of the board tray 110 to further reduce the overall profile of the puzzle storage apparatus 100 as illustrated in FIG. 5.

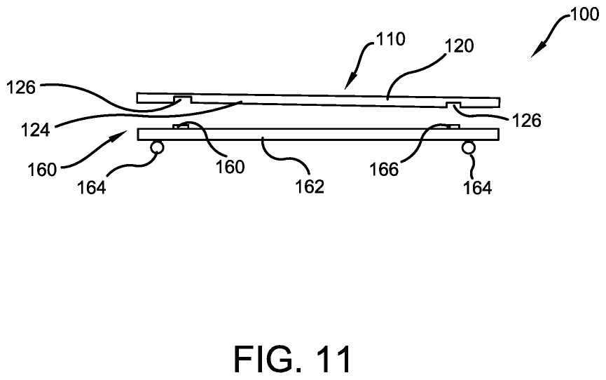

As illustrated in FIG. 11, the rolling component 150 may alternatively comprise a dolly 160. The dolly 160 or truck is attachable to the bottom surface 124 of the board tray 110. The dolly 160 is also detachable from the board tray 110 so that the board tray 110 may be placed on a counter or other elevated surface for use. The dolly 160 comprises a frame 162 and a plurality of castors 164 attached to the frame 162. At least one board tray attachment element 166, such as a pin or other mechanical connector is configured to engage and mate with at least one dolly attachment point 126 located on or within the bottom surface 124 of the board tray 110 to hold the board tray 110 in place on the dolly 160.

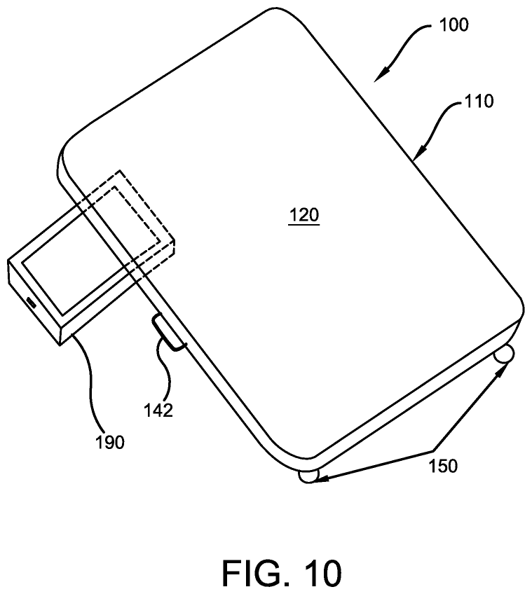

As illustrated in FIG. 6, the puzzle storage apparatus 100 may further comprise a plurality of legs 170. Each leg 170 may be foldably attached to the bottom surface 124 of the board tray 100 or may be completely removable when not needed. This allows the board tray 110 to elevate for use. Each leg 170 folds downward to allow the puzzle storage apparatus 100 to function as a table and retracts up against the bottom surface 124 for low profile storage. As illustrated in FIG. 7, the puzzle storage apparatus 100 may further comprise a lighting component 180 attachable to the board tray 110 for illuminating the top surface 120 of the board tray 110. The lighting component 180 may be a LED lamp or similar directional light operable with a battery. As illustrated in FIG. 10, the puzzle storage apparatus 100 may further comprise a drawer assembly 190. The drawer assembly 190 is attachable to the bottom surface 124 of the board tray 110 and extends outward from the perimeter wall 130. The drawer assembly 190 may be used to retain any puzzle pieces that have not yet been used.

Notwithstanding the forgoing, the puzzle storage apparatus 100 can be any suitable size, shape, and configuration as is known in the art without affecting the overall concept of the invention, provided that it accomplishes the above stated objectives. One of ordinary skill in the art will appreciate that the shape and size of the puzzle storage apparatus 100 and its various components, as show in the FIGS. are for illustrative purposes only, and that many other shapes and sizes of the puzzle storage apparatus 100 are well within the scope of the present disclosure. Although dimensions of the puzzle storage apparatus 100 and its components (i.e., length, width, and height) are important design parameters for good performance, the puzzle storage apparatus 100 and its various components may be any shape or size that ensures optimal performance during use and/or that suits user need and/or preference. As such, the puzzle storage apparatus 100 may be comprised of sizing/shaping that is appropriate and specific in regard to whatever the puzzle storage apparatus 100 is designed to be applied.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A puzzle storage apparatus comprising:
a board tray comprising a top surface, a bottom surface, and a perimeter wall comprising a front wall, a back wall, and a pair of side walls;
a rolling component attached to the bottom surface of the board tray configured to allow the puzzle storage apparatus to roll in any direction; and
wherein the board tray is twenty inches or less in depth between the front and back walls.

2. The puzzle storage apparatus of claim 1, wherein the top surface of the board tray is a non-slip surface.

3. The puzzle storage apparatus of claim 1, wherein the puzzle storage apparatus is two inches or less in height.

4. The puzzle storage apparatus of claim 1, wherein the board tray further comprises a lip extending upward along the perimeter.

5. The puzzle storage apparatus of claim 1, wherein the board tray further comprises at least one handle attached to the perimeter wall.

6. The puzzle storage apparatus of claim 1, wherein the rolling component comprises a plurality of casters.

7. The puzzle storage apparatus of claim 6, wherein each castor comprises a brake.

8. The puzzle storage apparatus of claim 6, wherein each castor folds inward.

9. The puzzle storage apparatus of claim 6, wherein each castor is mechanically or adhesively attached to the bottom surface of the board tray.

10. The puzzle storage apparatus of claim 1 further comprising a surface protective element removably attached to the board tray.

11. The puzzle storage apparatus of claim 1 further comprising a plurality of legs foldably attached to the bottom surface of the board tray.

12. The puzzle storage apparatus of claim 1 further comprising a lighting component attached to the board tray.

13. The puzzle storage apparatus of claim 1 further comprising a drawer assembly attached to the bottom surface of the board tray extendable outwardly from the perimeter.

14. A puzzle storage apparatus comprising:
a board tray comprising a non-slip top surface, a bottom surface, and a perimeter wall comprising a front wall, a back wall, and a pair of side walls connected at four corners;
a rolling component comprising a plurality of castors attached to the bottom surface of the board tray at each of the four corners configured to allow the puzzle storage apparatus to roll in any direction; and
wherein the puzzle storage apparatus is two inches or less in height and the board tray is twenty inches or less in depth between the front and back walls.

15. The puzzle storage apparatus of claim 14, wherein the board tray further comprises a first panel and a second panel extendable laterally out of the first panel.

16. The puzzle storage apparatus of claim 14, wherein the rolling component is detachable from the board tray.

17. The puzzle storage apparatus of claim 14 further comprising a surface protective element removably attached to the board tray.

18. The puzzle storage apparatus of claim 14, wherein each castor comprises a brake and folds up against the bottom surface of the board tray.

19. A puzzle storage apparatus comprising:
a board tray comprising a non-slip top surface, a bottom surface, and a perimeter wall comprising a front wall, a back wall, and a pair of side walls connected at four corners;
a rolling component comprising a dolly removably attachable to the bottom surface of the board tray, the dolly comprising a frame and a plurality of castors attached to the frame configured to allow the frame to roll in any direction; and
wherein the puzzle storage apparatus is two inches or less in height and the board tray is twenty inches or less in depth between the front and back walls.

20. The puzzle storage apparatus of claim 19 further comprising a lighting component attached to the board tray.
